(19) United States
(12) Patent Application Publication
(10) Pub. No.: US 2026/0073359 A1
(43) Pub. Date: Mar. 12, 2026

(54) CRITERIA BASED COMMUNICATION SCHEDULED SEND

(71) Applicant: Google LLC, Mountain View, CA (US)

(72) Inventor: Bernadette Alexia Carter, New York, NY (US)

(21) Appl. No.: 18/883,009

(22) Filed: Sep. 12, 2024

(51) Int. Cl. G06Q 10/1093; G06Q 10/107

(52) U.S. Cl. CPC G06Q 10/1093; G06Q 10/107

(57) ABSTRACT

The technology provides mechanisms to set criteria for when a scheduled send of a communication, such as an email, text message, chat message, etc., should occur. The criteria can be based on the state of a user's message inbox, their communication channels, and/or the status or actions of others to be communicated with. Machine learning can be used to either generate the criteria for when or how to respond, or to generate a recommended response. The system can reformat a communication by changing the tone of a message, or rework the communication for transmission in an alternative format/medium via a different messaging app. This can involve changing from an email message to a chat or audio message, replacing text with emoji or the like, adding visual indicia to the communication, and/or adding audible information to the communication.

### BACKGROUND

Email and other forms of electronic messaging are ubiquitous and used to communicate with family, friends, co-workers and others in many different types of situations. Such messaging is typically done in real time, meaning that a user generates a message, such as by typing it out or by speech-to-text, and then sending it to the recipient. In some situations, messages are prepared for sending at a future time rather than instantaneously in real time. For instance, upon creating an email, the user may select a date and time at which the email system will send the email. Thus, a work email may be scheduled for sending the next day during business hours for the recipient. However, this rigid approach may result in messages being sent unnecessarily, or sent with outdated information, e.g., when the reason or circumstances for the message has changed.

### BRIEF SUMMARY

Aspects of the technology include methods and systems that provide mechanisms to set criteria for when a scheduled send of a communication, such as an email, text message, chat message, etc., should occur. The criteria may be based on the state of a user's message inbox, their communication channels, the status or actions of others to be communicated with, or any combination thereof. Machine learning approaches may be employed, for instance to either generate the criteria for when or how to respond, or to generate a recommended response. By way of example, the system could reformat a communication, such as by changing the tone of a message, or rework the communication so that it can be transmitted in an alternative format/medium via a different messaging app (e.g., changing from an email message to a chat, including replacing text with emoji, adding visual indicia to the communication, and/or adding audible information to the communication).

According to one aspect of the technology, a method is provided for electronic communication, comprising: identifying, by one or more processors of a computing system, a scheduled future time to send an electronic message on behalf of a first user to one or more other users; determining, by the one or more processors based on a set of criteria using a trained large language model, that there has been a change in circumstance associated with the electronic message; and in response to the determining that there has been a change in the circumstance based on the set of criteria, the one or more processors performing at least one of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message; wherein automatically changing the scheduled future time is performed when the criteria includes a state of an inbox associated with the first user, a state of a communication channel associated with the first user, a status of one of the one or more other users, or an action of one of the one or more other users.

In one example, the change in circumstance includes a new message being received in a message thread of the electronic message. In another example, creating the alternative version of the electronic message includes revising the electronic message to include at least one of a shift in tone or a change in focus of the electronic message. Here, the shift in tone or the change in focus may be further based on at least one external factor associated with a current event, news, social media activity, or social media trend. In yet another example, proposing the alternative communication type for sending the version of the electronic message includes one of: changing from an email message to a text message; changing from an email message to a chat message; changing from a text message to an email message; changing from a text message to a chat message; changing from a chat message to an email message; or changing from a chat message to a text message. Creating the alternative version of the electronic message may include replacing selected text with a graphical indicia. Creating the alternative version of the electronic message may also or alternatively include adding visual indicia to the alternative version.

Alternative or in addition to any of the above, the method may further comprise the large language model creating the set of criteria. Alternative or in addition to any of the above, the method may further comprise the large language model updating the set of criteria based on one or more of the state of the inbox, the state of the communication channel, the status of one of the one or more other users, and/or the action of one of the one or more other users.

In an example, notifying the first user of the changing of the schedule future time or the change in circumstance may include the large language model generating a recommendation to the first user to respond to a received message. The change in circumstance may be associated with a relative importance of the electronic message. Proposing the alternative communication type for sending the version of the electronic message may include the large language model suggesting at least one of a change in formality or conciseness of the electronic message. The set of criteria may include at least criterion that is based on user input. Moreover, proposing the alternative communication type for sending the version of the electronic message may include one of: switching from a textual message to an audio message; switching from an email message to a blog or social media post; switching from a chat message to a blog or social media post; or switching from an instant message to a blog or social media post.

According to another aspect of the technology, a processing system is provided that comprises memory configured to store an electronic message to be sent on behalf of a first user, and one or more processors operatively coupled to the memory. The one or more processors are configured to: identify a scheduled future time to send the electronic message on behalf of the first user to one or more other users; determine, based on a set of criteria using a trained large language model, that there has been a change in circumstance associated with the electronic message; and in response to the determining that there has been a change in the circumstance based on the set of criteria, perform at least one of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message. Automatically changing the scheduled future time is performed when the criteria includes a state of an inbox associated with the first user, a state of a communication channel associated with the first user, a status of one of the one or more other users, or an action of one of the one or more other users.

The one or more processors may be configured perform any two or three of (1), (2), (3) and (4). The set of criteria may be created using the large language model. The large language model may be configured to update the set of criteria based on one or more of the state of the inbox, the state of the communication channel, the status of one of the one or more other users, and/or the action of one of the one or more other users.

According to yet another aspect of the technology, a computer-readable medium is provided having instructions stored thereon. The instructions, when executed by one or more processors of a computing system, perform a method for electronic communication, in which the method comprises: identifying a scheduled future time to send an electronic message on behalf of a first user to one or more other users; determining, based on a set of criteria using a trained large language model, that there has been a change in circumstance associated with the electronic message; and in response to the determining that there has been a change in the circumstance based on the set of criteria, performing each of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message; wherein automatically changing the scheduled future time is performed when the criteria includes a state of an inbox associated with the first user, a state of a communication channel associated with the first user, a status of one of the one or more other users, or an action of one of the one or more other users. Here, notifying the first user of the changing of the schedule future time or the change in circumstance may include the large language model generating a recommendation to the first user to respond to a received message.

### BRIEF DESCRIPTION OF THE DRAWINGS

FIG. 1 illustrates an example messaging scenario in accordance with aspects of the technology.

FIG. 2 illustrates a Transformer-type architecture for use in accordance with aspects of the technology.

FIG. 3 illustrates an example scheduled messaging architecture in accordance with aspects of the technology.

FIG. 4 illustrates an example system in accordance with the messaging architecture of FIG. 3 and other aspects of the technology.

FIGS. 5A-B illustrate example scenarios in accordance with aspects of the technology.

FIGS. 6A-B illustrate a system for use with aspects of the technology.

FIG. 7 illustrates a method in accordance with aspects of the technology.

### DETAILED DESCRIPTION

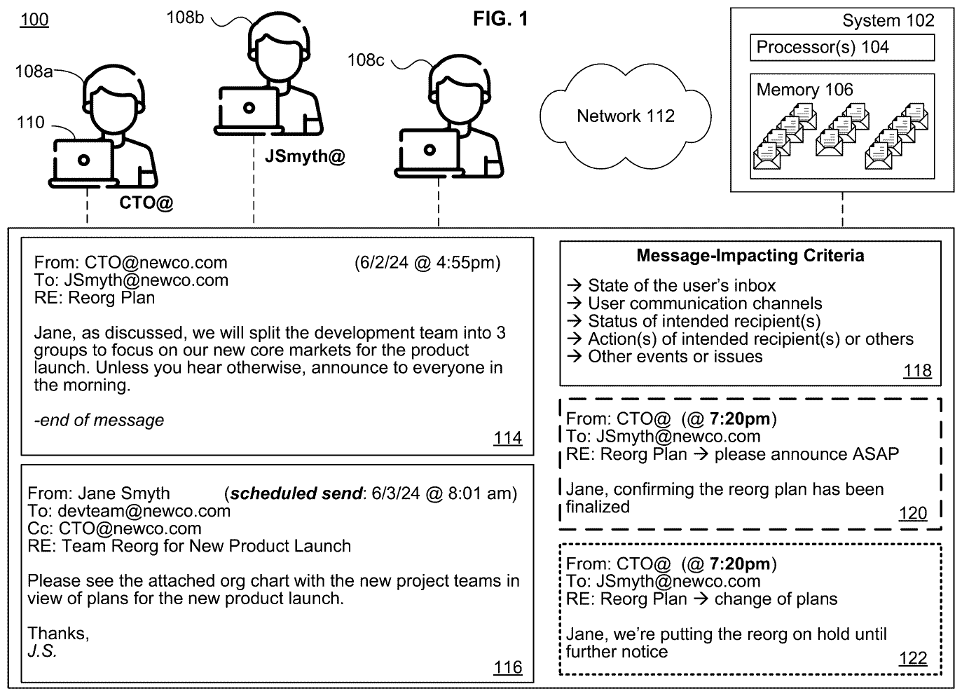

An exemplary scenario 100 in accordance with the technology is presented in FIG. 1. This illustrates a situation in which a user receives an electronic message (in this example an email message) from one person, and in view of that prepares another electronic message related to the received message. The prepared message is set to be sent by the email app to one or more recipients at a future point in time.

In this scenario 100, computing system 102 may be part of, e.g., an app for a specific company or school, a web-based email service, a messaging service or the like. As shown, the computing system 102 includes one or more processors 104 and memory 106 for storing data. By way of example, the data may include user preferences, email thread information, calendar or other availability information, a content library or set of files (e.g., audio, video, docs), external events, news, current trends, etc. The system 102 may receive emails or other electronic communication from users 108 via the users' devices 110 and a communication network 112, such as the Internet. While only a few users 108 and user devices 110 are shown, there may be many such users and devices (e.g., tens, hundreds, thousands or more).

The bottom portion of the scenario 100 illustrates several aspects related to delayed messaging or other scheduling a time to send an electronic message. For instance, in section 114 an exemplary received email is shown, with a subject line of “Reorg Plan”. In this example, the email is from the CTO of an organization (here CTO@newco.com, e.g., user 108a) to a particular person in the organization (here Jane Smyth, jsmyth@newco.com, e.g., user 108b). In this scenario, the received email provides information about a planned team reorganization. As illustrated in section 114, the email was received at 4:55 pm on Jun. 2, 2024), and the body of the message states “Jane, as discussed, we will split the development team into 3 groups to focus on our new core markets for the product launch. Unless you hear otherwise, announce to everyone in the morning.”

As shown in the figure, the person who received the email has prepared an email, which is based on the information from the CTO. In particular, section 116 illustrates the prepared email. This email, with a subject line of “Team Reorg for New Product Launch” will be sent to specific employees (here employees in the devteam@newco.com email group, such as user 108c). This email states “Please see the attached org chart with the new project teams in view of plans for the new product launch.” As illustrated in section 116, this email is scheduled to be sent at 8:01 am on Jun. 3, 2024.

In a conventional approach, the messaging system may only allow a user to schedule a time for when a message is to be sent. This does not allow for addressing criteria that could be used to cancel transmission of the message, modify when the message should be sent, the information in the message, the type of message to be sent, or other relevant criteria. By way of example, and as discussed in detail below, one aspect of the technology may evaluate certain message-impacting criteria as shown in section 118. This can include the state of the user's inbox (which may include whether messages from certain people have been received or not, whether specific keywords are included in the subject line or body of the message, whether specific people, user IDs or @mentions are included within a message or otherwise as a recipient to the message, etc.), the types of available user communication channels (e.g., email, chat, instant message, etc.), status of one or more intended recipients (e.g., a person has blocked off or removed focus time from their calendar or other app), an action of one or more intended recipients or other people involved in a message thread, or other events or issues that may impact the message or when to send it. By way of example, this could include external events, news, social media activities/trends, etc. Such criteria can be employed to modify timing of message transmission (or to not transmit a message), content of the message and/or what type of communication channel should be used for messaging.

Dashed section 120 and dotted section 122 provide examples that can impact when or how the message in section 116 is to be sent. For instance, as shown by the message in dashed section 120, Jane receives a follow-up message from the CTO with an updated subject line (“Reorg Plan→please announce ASAP”), with the body of the message stating “Jane, confirming the reorg plan has been finalized”. Here, the follow-up message indicates to the recipient a change in circumstance, in particular that the reorganization plan should be announced as soon as possible (or other change of relative importance in sending the message. Instead of waiting until 8:01 am the following morning, the queued-up message should ideally be sent immediately (e.g., as a first-class reply), even though it may be after regular business hours. Thus, when the system detects the change in circumstance, here, the follow-up email, according to one aspect of the technology the queued-up email may be sent immediately instead of waiting for the designated time.

In contrast, as shown by the message in dotted section 122, Jane instead receives a follow-up message from the CTO with an updated subject line (“Reorg Plan→change of plans”), with the body of the message stating “Jane, we're putting the reorg on hold until further notice”. Here, the follow-up message indicates to the recipient a different type of change in circumstance, in particular that the reorganization plan has been put on hold. Therefore, instead of sending the queued-up message at 8:01 am the following morning, that message should not be sent. Thus, when the system detects the change in circumstance, here, the follow-up email, according to one aspect of the technology the queued-up email may be removed from the send queue. A warning, notice or other indicator may be presented to the user (here user 108b) regarding the change in circumstance and/or an explanation of why the message has not or will not be sent as originally scheduled. In another scenario, the sender and recipient may collaborate on a shared document that reflects the contents referenced in section 116. In this case, there may be a notification to the sender when their actions may impact the validity of the shared document or workflow that is intended to be initiated with the message send (e.g., increase an access control list (ACL) on a document with details of a reorganization).

Aspects of the technology can employ machine learning and/or heuristic-based approaches for criterial-based scheduled electronic messaging situations.

Given this, the present technology will now be described with respect to the following exemplary systems and methods.

In one implementation, the system may employ a trained neural network, such as a large language model (LLM) for use in natural language processing (NLP), in order to analyze electronic messages and associated information, determine if any relevant criteria have been met, and use this information to modify an existing message to be sent, to generate a recommendation to respond to a received message, or generate the criteria for responding to a received message.

In particular, the system can use a large “foundation” (e.g., a baseline) language model, and then build a “fine-tuning” on top of that. The foundation model “knows” or otherwise understands language in general, from training over a very large data set, such as a database of email messages, chats, instant messages, or the like. The fine-tuning may be done using specific types of information, such as potential message-impacting criteria (e.g., such as shown in section 118 of FIG. 1, described above.

The model may employ, by way of example, a Transformer-type architecture, a convolutional neural network (CNN), recurrent neural network (RNN), long short-term memory (LSTM) network or combination thereof. For instance, the machine learning model may employ a Transformer-type machine learning architecture as discussed in U.S. Pat. No. 10,452,978, entitled “Attention-based sequence transduction neural networks”, the entire disclosure of which is incorporated herein by reference.

In one scenario, fine-tuning may employ a Low-rank adaptation (LoRA) approach. This is an adapter-based technique used to fine-tune models. LoRA reduces the computational burden, allowing faster adaptation of models. This approach may employ significantly fewer trainable parameters than the underlying model, which can make it more computationally efficient to fine-tune an LLM.

The trained and fine-tuned model may be configured to interact with users via a user interface module of the system. This can include creating a set of criteria for message responses (e.g., when and how to respond), automatically sending a message when certain criteria are met, having a back-and-forth dialogue with a person drafting a message to be sent to better understand user preferences and/or to propose different schedule send options to best achieve everyone's meeting goals, etc.

A detailed discussion of the various aspects of the technology are presented below.

### Exemplary Neural Network Architecture

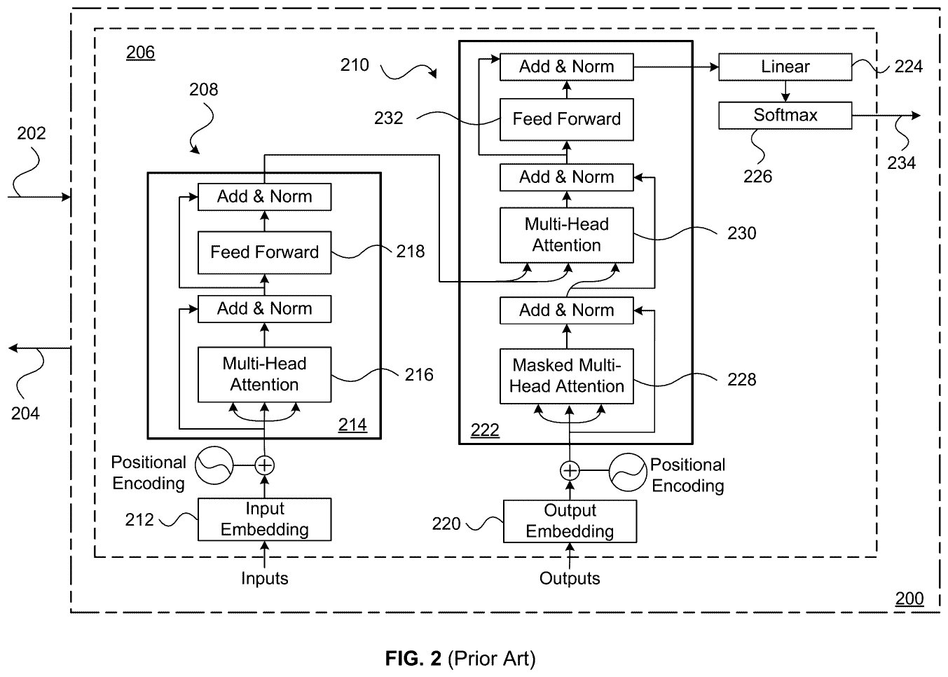

As noted above, the system may employ a language model based on one of a number of different model architecture types. By way of example only, a Transformer architecture is presented in FIG. 2. In particular, system 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also includes a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

### Exemplary Scheduled Messaging Operation and Architecture

The technology provides mechanisms to set criteria, e.g., based on actions of one or more people, the state of the user's inbox or their communication channel(s) and/or other factors, for when a scheduled send of an electronic communication should occur. The electronic communication may be, e.g., an email, text message or chat message, which has been prepared by the user to be transmitted to one or more recipients at a future time. For instance, the criteria may be used to cause the messaging system to send the electronic communication at a previously selected time if no additional messages have been received on the email (or other communication) thread since the scheduled send was set in the system.

Alternatively, the criteria may be used to accelerate sending of the electronic message. This can occur, e.g., upon a certain inbox or chat application state being met. By way of example, the criteria may be: send the communication if the user has received a message that fits any combination of the following: (i) receive a new message from person A, (ii) receive a new message having a subject line or message body that includes one or more specified terms, and/or (iii) receive a new message in which one or more specified people, usernames, or email/message addresses are cc'd or @mentioned. For instance, the scheduled send time of a chat message may be set for the next business day for the recipient at 1 pm local time. The criteria to accelerate sending may be to send the message immediately (or within some other, earlier, timeframe) if the recipient's status has changed from either “offline” or in “focus time” to “active” and the recipient has not sent a message to the user in any other communication channel since the send time was scheduled.

In another scenario, the criteria may be used to cancel or otherwise defer the scheduled send. Or, alternatively, the criteria may be used to trigger a notification to the user to modify the content of the communication to be sent and/or the scheduled send time for the communication. Optionally, the messaging system may suggest to the user changes for content modification and/or the send time, or may automatically draft a revised version of the communication. By way of example, the system may be trained for typical responses via a message corpus. Based on this, the system can generate a responsive message, generate a recommendation to respond to a received message, generate the criteria for responding to messages, etc.

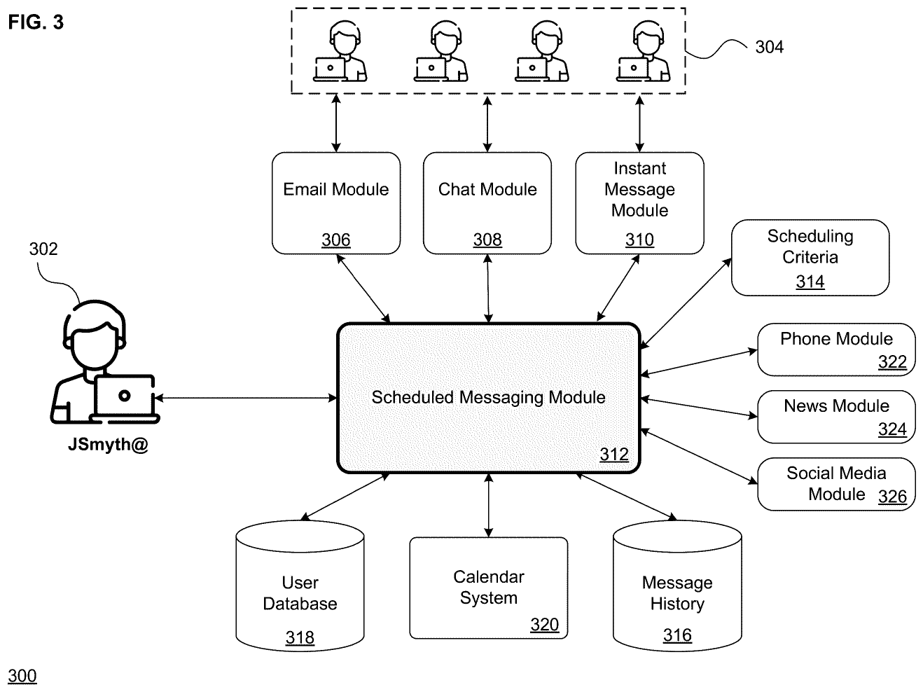

FIG. 3 illustrates a high-level system example 300 that implements a criteria-based scheduled messaging architecture in accordance with aspects of the technology. This arrangement illustrates a user 302 that can interact with the system when dealing with scheduled send messaging. The user 302 can communicate with one or more other people 304 via the system. This may be done, for instance via electronic mail (email) module 306, chat module 308, and/or instant messaging module 310 (or “communication modules”). The email module 306, chat module 308 and instant message module 310 may be separate modules configured to handle specific types of electronic communications. Alternatively, there may be one electronic messaging module configured to handle one or more types of electronic messages including, but not limited to email, chat, instant messages, videoconferences, or the like.

In this configuration, the communication between the user 302 and the other people 304 via the module(s) 306, 308 and/or 310 involves a scheduled messaging module 312. As shown the scheduled messaging module 312 is configured to interact with the user 302 and with the communication modules for both incoming and outgoing messaging. In particular, the scheduled messaging module 312 can interact with the user 302 to identify relevant scheduling (e.g., message impacting) criteria 314 that can be applied in order to determine when, and how, to send a pre-prepared message to one or more of the people 304. This can include a user interface (UI) in which the user can select or create a set of criteria, either for a specific message to be sent and/or as a baseline set of requirements for any messages to be sent from that user. It can also include the scheduled messaging module 312 performing natural language processing on input from the user and/or other contextual information in order to create or suggest one or more criteria.

In this configuration, there are a number of databases and other modules used by the scheduled messaging module 312. Message history database 316 may be used by the module 312 to identify relevant historical message-related information in order to identify the scheduling criteria 314 and/or to determine whether such criteria have been met for a given message (e.g., whether a specific pattern been met, so that the scheduled message can be sent). This could also include identifying a date change from prior correspondence. User database 318, which may be part of an existing organization directory (or another system which contains user profiles), may store user messaging preferences. Such preferences can include when to send certain types of messages (e.g., immediate send of team reorganization emails when a confirmation notice indicate that the reorg has been finalized or when the team leads are all on-line), what communication format/medium to use (e.g., email versus text versus instant message), etc. And calendar system 320 can provide the scheduled messaging module 312 with status/availability information for the user 302 and/or people 304. Thus, when the scheduling criteria 314 for a happy birthday message to a given person 304 requires that the person's status change to on-line from offline or focus time and that the system wait 15 minutes, a change in that person's status may be identified via the calendar system.

As shown, the system may include other modules, such as a phone module 322, a news module 324 and/or a social media module 326. By way of example, the phone module 322 may provide the scheduled messaging module 312 with call transcript, voicemail, call log or other information. The news module 324 may provide the scheduled messaging module 312 with, for example, notifications regarding current events impact. And the social media module 326 may provide the scheduled messaging module 312 with information about social interactions, which may include or reference a particular user, or involve topics relevant to a message to be sent. A current event or an item trending social media may warrant a change in tone of a message to be sent. In another example regarding the news module 324, if a breaking event has happened related to the content of the upcoming missive, then that may influence scheduling (e.g., either delay or cancel). In another example regarding the social media module 326, if the topic of the missive is trending in a certain direction (e.g., positively) or conversations are going on either by the prospective recipients of the missive or content may be determined to no longer be in good taste, then that could influence scheduling (e.g., either delay or cancel). On the other hand, if topic is trending in a different direction (e.g., negatively), then this may result in accelerating release of content because it may be determined that the “information is already out there.” The system may enable switching communication from an email or chat to a blog or social media post via the social media module 326 (and/or the email module 306, chat module 308 or instant message module 310). And in another example regarding the phone module 322, the system may use this module to enable switching from a textual message to an audio message (either via a phone call or via a messaging service).

In one approach, the scheduled messaging module 312 includes a natural language processing (NLP) component which includes a pre-trained (large) language model (LLM). In one scenario, the LLM may be an API hosted by a foundation model. The LLM may have been fine-tuned during a training process for the scheduled message send task. By way of example, LLM fine-tuning may have used message-related data or other data (e.g., subject line or message keywords, graphical indicia such as emoji, message importance tiers, message follow-up flags, receipt requests, example scheduling criteria, etc.).

For instance, the scheduled messaging module 312 can be used by user 302 to set message send criteria in unstructured, natural language specification (e.g. “I prefer to wait 15 minutes after a person comes out of focus time before instant messaging them”, or “when we get the go-ahead from the VP, send the reorg email ASAP!”). That information may then be stored in the user database 318, with corresponding message send requirements added to the scheduling criteria 314. The user input does not need to be pre-processed or transformed prior to storage. Thus, a user may be able to update general message send preferences or scheduling criteria for a specific message. They can also review and modify any messages flagged by the scheduled messaging module 312, cancel sending of messages, etc. Alternative configurations are possible, and are within the scope of the present technology. For instance, the scheduled messaging module 312 may employ a multi-turn dialog interface when interacting with the user regarding preferences and/or scheduling criteria.

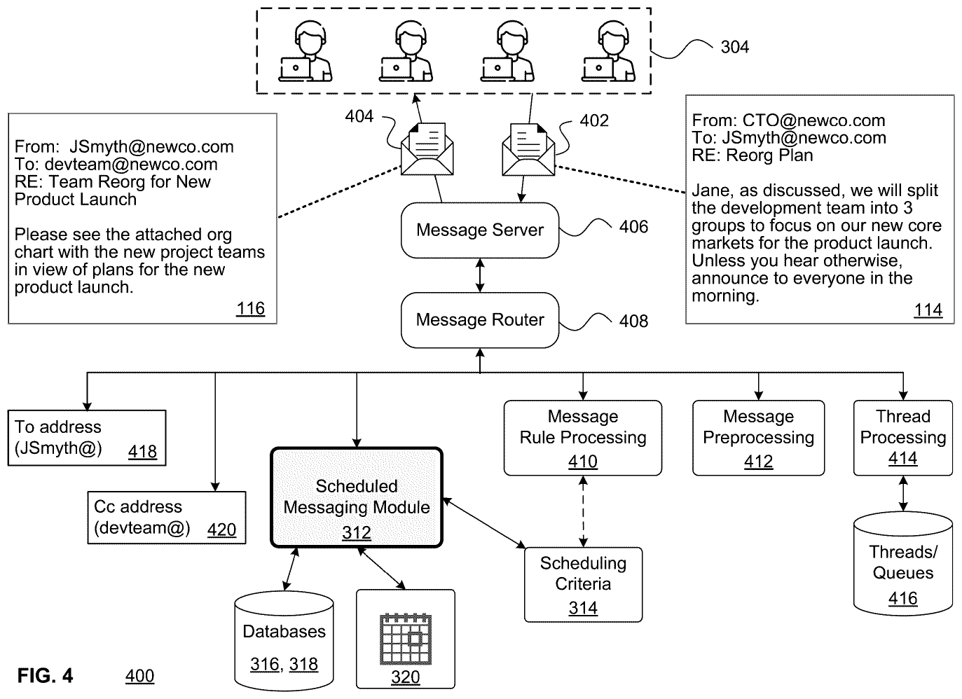

FIG. 4 illustrates an example of the architecture of FIG. 3 in view of the messaging scenario 100. For purposes of this example, reference is made to email messages. However, other types of electronic messages (e.g., chats, instant messages, or the like) could be used alternatively or additionally to email messages as noted above. In this example, incoming messages 402 (such as email 114 from CTO@newco.com to JSmyth@newco.com) and outgoing messages 404 (such as email 116 from JSmyth@newco.com to devteam@newo.com) pass through an electronic messaging system. In particular, an incoming email 402 enters the system from the outside world (e.g., sent from a person 304 intended for user 302 of FIG. 3) via a messaging server 406. The messaging server 406 may be, by way of example, a simple mail transfer protocol (SMTP) server, although other types of messaging servers may be employed.

The messaging server 406 is, in this scenario, the interface to the outside world (e.g., to the people 304). It passes incoming emails 402 to a message router 408, and outgoing emails 404 from the message router 408 to the people 304. The message router 408 may route a given incoming email 402 to one or more modules, as well as to one or more inboxes. For instance, the given email may be routed to a message rule processing module 410, a message preprocessing module 412 and/or a thread processing module 414.

The message rules processing module 410 can manage one or more rules that indicate to which inboxes or specific people the incoming message will be sent. Another type of rule may be whether or how to preprocess an email message so that it can be used for training (e.g., fine-tuning of the LLM used by the scheduled messaging module 312). As show, the message rule preprocessing module 410 may be configured to read from or write to the scheduling criteria 314. Thus, in one example when the scheduled messaging module 312 is not employed, the system may still implement a set of message send criteria for messages to be sent at a future time.

The message preprocessing module 412 may be configured to perform certain operations on the incoming email message 402, either for training purposes or so that a trained scheduled messaging module can effectively act on the message. The operations may include one or more of identifying relevant people included in either a “to” or “cc” line (see blocks 418 and 420), removing headers, stripping out a signature line or signature block, deleting quoted text (e.g., prior message segments in an email thread, which may begin with a “>” character or other leading character(s)), discard ambiguous or malformed emails, remove attachments, etc. Alternatively or additionally, attachments may be used to help with training the scheduled messaging module 312 or otherwise generate scheduling criteria 314. For instance, if an attachment is determined to be relevant to a message to be sent (e.g., an agenda for a meeting or a set of action items to address prior to the meeting), information corresponding to the attachment may be used as an input during agent training. Thus, in one scenario, an attachment (e.g., a PDF-, RTF- or DOCX-type text-based electronic document or other type of electronic document) can be preprocessed to extract content as a text string, which is then passed to the training module or used by the trained assistant when creating or modifying scheduling criteria, or when making a suggestion to the user to modify a message or whether to send the message. Alternatively, the processing may result in replacing or dropping an attachment.

The thread processing module 414 may be configured to identify whether an incoming or outgoing message is part of a given thread, e.g., an outgoing message that is addressed to a particular outside recipient, who recently sent an incoming email to the messaging system. The thread processing module 414 may correlate incoming and outgoing messages, in addition to matching email addresses. By way of example, once an email comes in, the thread processing module 414 may put it into a queue, which is saved in memory (such as threads/queues database 416) to keep track of the thread for a certain amount of time.

The thread processing module or another module in the messaging system can organize discrete incoming emails into threads, such as by using the Subject line and/or other headers that mail clients provide. According to one aspect of the technology, the system can use its ordering of the mail thread when evaluating the scheduling criteria to determine when (or if) a message should be sent.

Once any of the processing modules (e.g., modules 410, 412 and/or 414) process a given email message, that email message can be sent to the message router 408 for appropriate distribution. As indicated above, the input email messages, or processed versions of those messages, may be routed to one or more inboxes or email addresses via the message router 408. This may include routing the message 114 to JSmythe@newco.com as shown at block 418. And the message 116 from JSmyth@newco.com, which can be sent either with the original scheduled send time or a modified scheduled send time based on a set of scheduling criteria 314, can be sent to devteam@newco.com recipient list.

### Scheduled Send Messaging Examples

As noted above, the system may use scheduling criteria, with or without other information, to perform various actions. This can include sending a message at a previously selected time if no overriding condition occurs, sending the message earlier or later than the previously selected time (or not at all), if a relevant condition occurs, recommending modifying a previously prepared message, or automatically generating a new message or modifying/reformatting the previously prepared message.

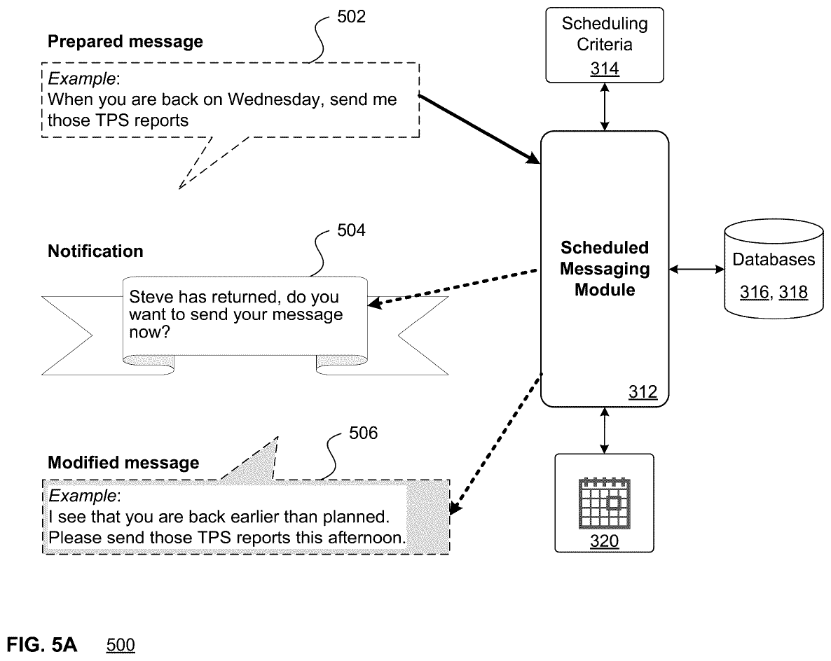

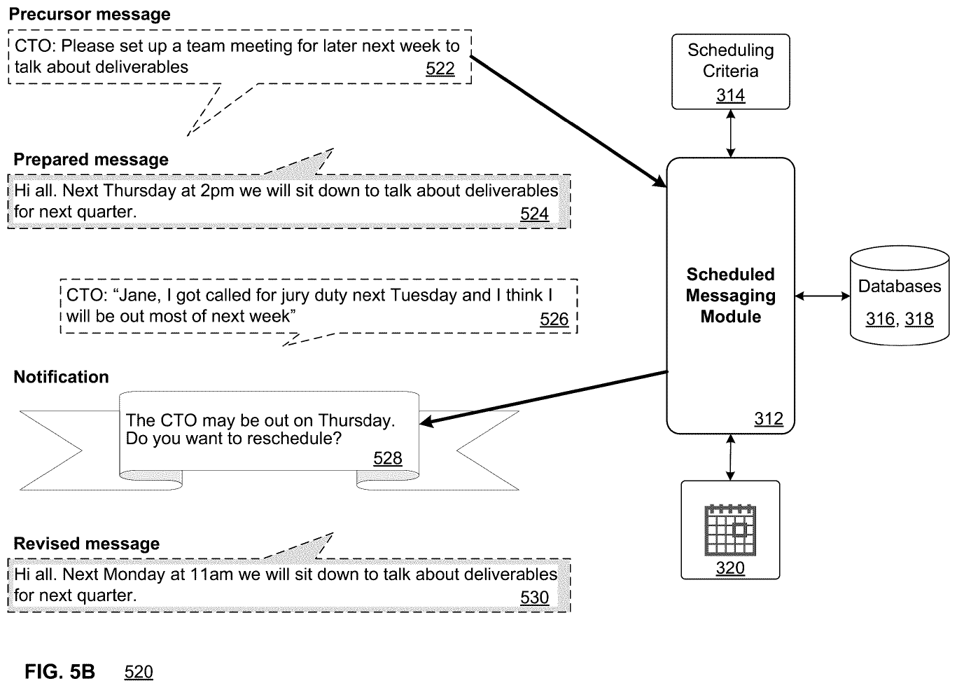

FIG. 5A illustrates an exemplary scenario 500 for modifying the planned send time for a message. Here, assume a user has prepared a message 502 to be sent once the recipient returns from being out of office (“When you are back on Wednesday, send me those TPS reports”). This message 502 may be a chat message, instant message or an email, for instance. The scheduled messaging module 312 evaluates the scheduling criteria 314, which in this scenario may include at least one of (i) the recipient's status changes from “offline” to “online” or “in focus time”, (ii) the recipient has sent an email or other message to the user since the message 502 was prepared, (iii) the user has received a message from anyone with the phrase “Steve is back”, or (iv) a calendar shared by the recipient indicates that they have returned from being out of office. Once any of these criteria has been met, the scheduled messaging module 312 may notify the user, such as shown by notification 504 (“Steve has returned, do you want to send your message now?”). Or, alternatively, the scheduled messaging module 312 may revise the original message 504 and propose it to the user, as shown in block 506 (e.g., “I see that you are back earlier than planned. Please send those TPS reports this afternoon”).

FIG. 5B illustrates another exemplary scenario 520 in which intervening messages may warrant modification to the originally prepared message. Here, there is a precursor message to a user, such as from the CTO (e.g., “Please set up a team meeting for later next week to talk about deliverables”). Based on this, assume that the user has prepared a message 524 to be sent to a group of recipients the next business day (e.g., “Hi all. Next Thursday at 2 pm we will sit down to talk about deliverables for the next quarter.”). Before that time, a message 526 is received in this thread by the system (CTO: “Jane, I got called for jury duty next Tuesday and I think I will be out most of next week”). In this situation, the scheduled messaging module 312 determines that this intervening message 526 satisfies criteria for the message 524, in particular that an intervening message has been received. In this case, the module 312 notifies the user that they may want to review the prepared message 524. In particular, at block 528, the notification may say “The CTO may be out on Thursday. Do you want to reschedule?”. Here, the user may act on this notification and revise the prepared message as shown at block 530 (“Hi all. Next Monday at 11 am we will sit down to talk about deliverables for next quarter.”). Thus, in this scenario, the system provides a sanity check before the user's message is sent.

In another scenario, the scheduled messaging module may evaluate message in the thread to suggest a shift in tone or focus of the email. For instance, if an intervening message indicates that there is some time urgency for the prepared message, then the notification may indicate that. Thus, if the intervening message 526 from the CTO said “Jane, we need to hammer out some timing issues with the deliverables for the project ASAP”, then the module may indicate to the user that they may want to emphasize the time-sensitive nature in a revised communication. Or the intervening message may indicate that the focus associated with the prepared message has changed. Here, the intervening message 526 from the CTO may include “The deliverables are important, but I really need to know how much headcount is required in Q3”. In this case, the module may indicate to the user that they may want to rephrase the prepared message to address the headcount issue. In these situations, the module may use NLP to evaluate the content and/or tone of the messages, and to present recommendations (or a proposed revised message) to the user.

In an example, a shift in communication tone may be suggested in response to current news or a shift in social media occurs. In another example, if the topic of a message thread changes, the system can leverage a trained model to rephrase, pause, and/or potentially loop in additional people to strategize reply before sending. This may be particularly helpful for situations involving messages to be sent regarding human resources, management decisions, or sensitive issues where having an expert in the area provide input may be suitable.

In a further scenario, the scheduled messaging module may seamlessly change communication types. For instance, the user may have prepared an email to a group of friends about a surprise birthday party for another friend. One of the scheduling criteria may be whether at least two of the group of friends are currently online. The scheduled messaging module may identify that this criterion is met by a group chat including the user. In this case, the module may reformat the email message to be sent as a text message or instant message. This reformatting may include adding emoji or replacing certain words with emoji, gif, meme, or other graphical indicia (e.g., with a symbol of a cake (such as [symbol] ) instead of the word “cake”). Then this text message may be presented to the user so they can confirm whether it should be sent in place of the email message. Alternatively, the system could create reformatted messages to be sent via different communication channels in addition to the original format. So in the above example, the email with the surprise birthday party invitation may be sent to all invitees, while texts, chats and/or instant messages are also sent to some or all of the invitees (e.g., according to the communication channels on which specific invitees are currently active). Moreover, when changing or selecting a communication type, the system may suggest a more formal response via email, or a more concise and/or less formal response via text or chat.

### Example System and Method

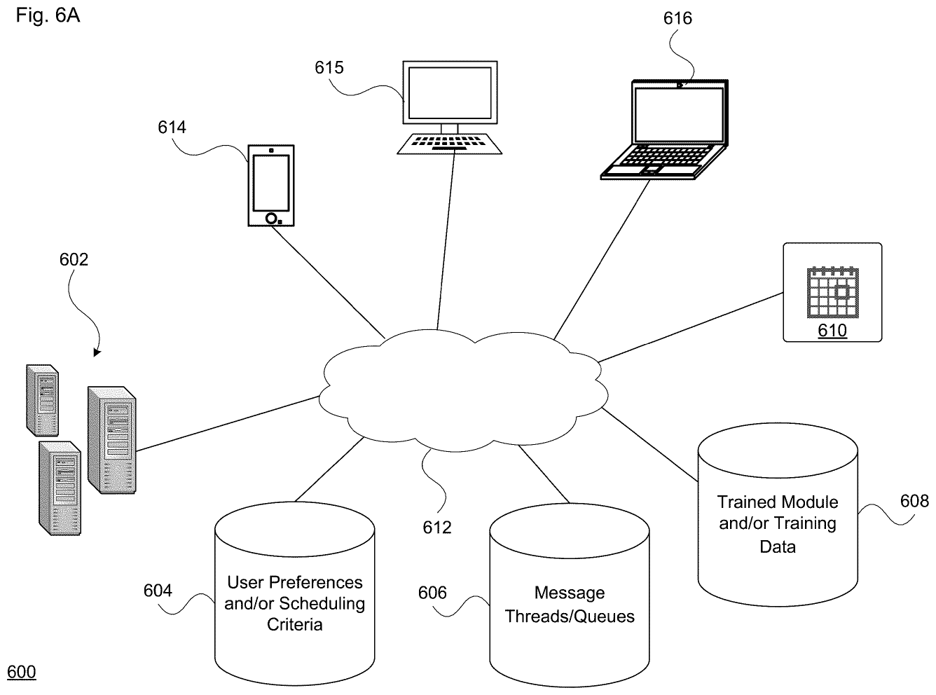

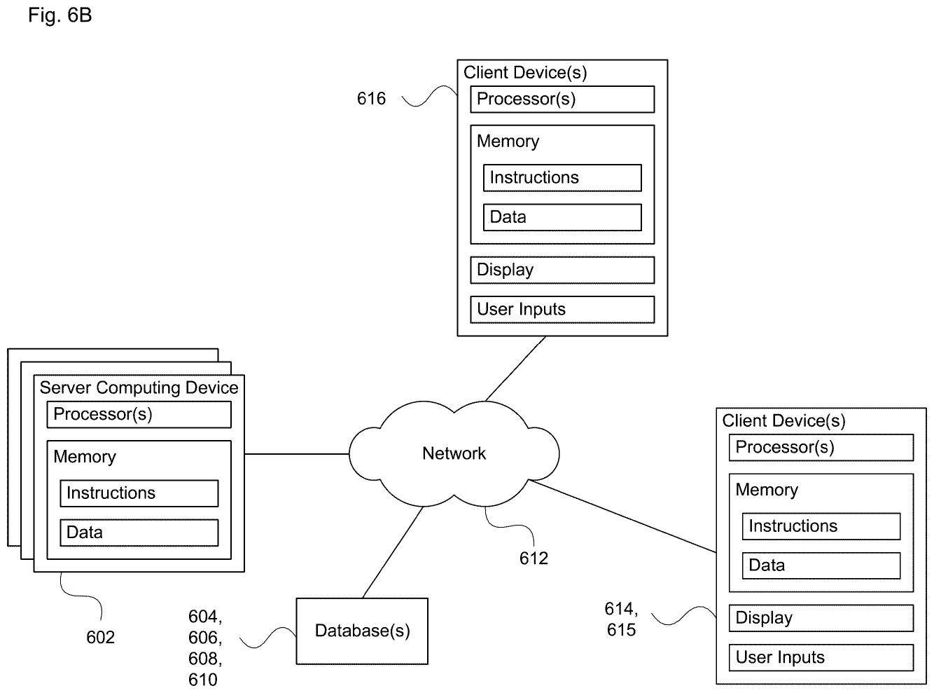

The scheduled messaging module described herein may be trained on one or more tensor processing units (TPUs), graphics processing units (GPUs), CPUs or other computing architectures. One example computing architecture is shown in FIGS. 6A and 6B. In particular, FIGS. 6A and 6B are pictorial and functional diagrams, respectively, of an example system 600 that includes a plurality of computing devices and databases connected via a network. For instance, computing device(s) 602 may be a cloud-based server system that can be used as a training pipeline or to provide a trained scheduled messaging module. The computing device(s) 602 may implement the message server 406, the message router 408, and the processing modules 410, 412 and 414, as well as threads/queue database 416. The device(s) 602 may also host the various email addresses 418 and/or 420. Moreover, these devices may be configured to implement the scheduled messaging module 312.

Databases 604, 606, 608 and 610 may store, e.g., user preferences and/or scheduling criteria, threads/queues for messages, training data, a trained scheduled messaging module, calendars, etc. The server system may access the databases via network 612. Client devices may include one or more of a mobile phone 614, desktop computer 615 and a laptop or tablet PC 616. Once a scheduled messaging module has been trained, it may be implemented by the servers, computing devices 614-616 to handle messages scheduled to be sent.

As shown in FIG. 6B, each of the computing devices 602 and 614-616 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, GPUs, etc. Alternatively, each processor may be a dedicated device such as an ASIC or other hardware-based processor. Although FIG. 6B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 602. Accordingly, references to a processor or computing device will be understood to include references to a collection of processors or computing devices or memories that may or may not operate in parallel.

Reference to “one or more processors” herein includes situations where a set of processors (e.g., two or more CPUs, TPUs, GPUs or any combination thereof) may be configured to perform one or more operations. Any combination of such a set of processors may perform individual operations or a group of operations. Therefore, reference to “one or more processors” does not require that all processors in the set must perform all of the operations. Rather, unless expressly stated, any one (or different combinations) of the one or more processors may perform different operations when a set of operations is indicated. For instance, different processors may perform specific operations. For example, a first processor performs receiving and routing of incoming electronic messages, while a second processors performs one or more of evaluating user preferences, determining whether a meeting can be scheduled, automatically scheduling the meeting and/or generating an electronic message responsive to the original meeting request.

Received data, such as emails, chats, instant messages, etc., may be operated on by the modules, models and processes described herein. The computing devices may utilize such information in various apps or other programs to perform message-related operations. The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-focused types of computing devices (e.g., 614-616) may communicate with a back-end computing system (e.g., server 602) via one or more networks, such as network 612. The network 612, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are capable of communicating with any of the computing devices 614-616 via the network 612.

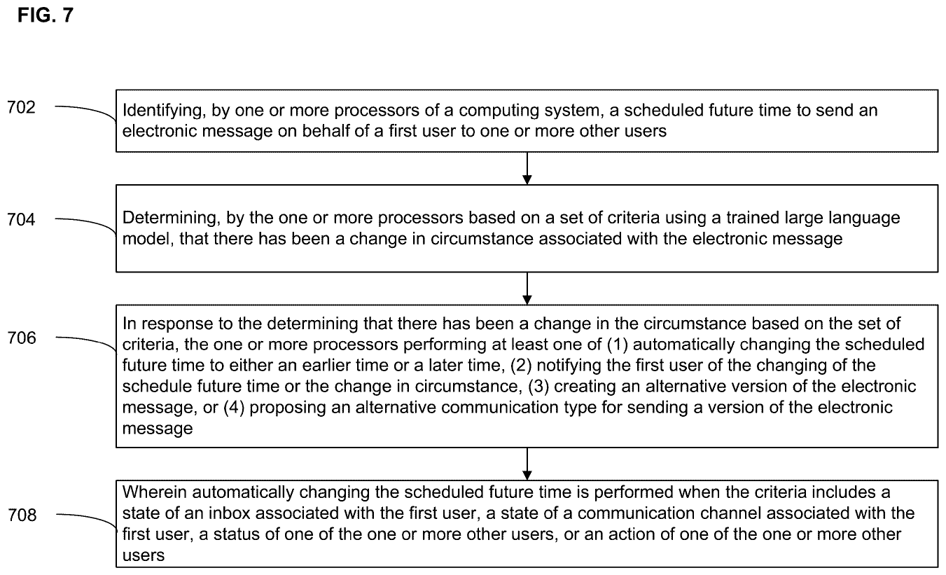

FIG. 7 illustrates a flow diagram 700 illustrating an example process according to the approaches discussed herein. In block 702, the method includes identifying, by one or more processors of a computing system, a scheduled future time to send an electronic message on behalf of a first user to one or more other users. At block 704, the method includes determining, by the one or more processors based on a set of criteria using a trained large language model, that there has been a change in circumstance associated with the electronic message. In block 706, in response to the determining that there has been a change in the circumstance based on the set of criteria, the method includes the one or more processors performing at least one of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message. In one scenario, any two of items (1)-(4) are performed. In another scenario, any three of items (1)-(4) are performed. And in a further scenario, all of items (1)-(4) are performed. Finally, in block 708, automatically changing the scheduled future time is performed when the criteria includes a state of an inbox associated with the first user, a state of a communication channel associated with the first user, a status of one of the one or more other users, or an action of one of the one or more other users

The above-described approaches provide enhanced communication options and the ability to more efficiently and effectively use computing resources of messaging systems to ensure that messages which are scheduled to be sent are only sent when relevant criteria have been met. This allows a user to review pre-scheduled messages when the system (e.g., the scheduled messaging module) determines that an intervening event or action has occurred, a person's availability has changed, and/or other criterion of interest warrants the review. In some aspects, the system itself may automatically send, revise, suggest revisions to the scheduled message, or even reformat the message so that it can be transmitted via a different communication medium.

Further to the descriptions above, a user may be provided with controls allowing the user to make an election as to both if and when systems, programs, modules or features described herein may enable collection of user information (e.g., information about a user's email address, chat handle or username, preferences, or current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Moreover, a user or a group of users, may be provided with controls enabling authorization to use messages associated with that user or group during training. Thus, the user (or group of users) may have control over what information is collected about the user (or the group), how that information is used, and what information is provided to the user or to others.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A method for electronic communication, comprising:
identifying, by one or more processors of a computing system, a scheduled future time to send an electronic message on behalf of a first user to one or more other users;
determining, by the one or more processors based on a set of criteria using a trained large language model, that there has been a change in circumstance associated with the electronic message; and
in response to the determining that there has been a change in the circumstance based on the set of criteria, the one or more processors performing at least one of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message;
wherein automatically changing the scheduled future time is performed when the criteria includes a state of an inbox associated with the first user, a state of a communication channel associated with the first user, a status of one of the one or more other users, or an action of one of the one or more other users.

2. The method of claim 1, wherein the change in circumstance includes a new message being received in a message thread of the electronic message.

3. The method of claim 1, wherein creating the alternative version of the electronic message includes revising the electronic message to include at least one of a shift in tone or a change in focus of the electronic message.

4. The method of claim 3, wherein the shift in tone or the change in focus is further based on at least one external factor associated with a current event, news, social media activity, or social media trend.

5. The method of claim 1, wherein proposing the alternative communication type for sending the version of the electronic message includes one of:
changing from an email message to a text message;
changing from an email message to a chat message;
changing from a text message to an email message;
changing from a text message to a chat message;
changing from a chat message to an email message; or
changing from a chat message to a text message.

6. The method of claim 1, wherein creating the alternative version of the electronic message includes replacing selected text with a graphical indicia.

7. The method of claim 1, wherein creating the alternative version of the electronic message includes adding visual indicia to the alternative version.

8. The method of claim 1, further comprising the large language model creating the set of criteria.

9. The method of claim 1, further comprising the large language model updating the set of criteria based on one or more of the state of the inbox, the state of the communication channel, the status of one of the one or more other users, or the action of one of the one or more other users.

10. The method of claim 1, wherein notifying the first user of the changing of the schedule future time or the change in circumstance includes the large language model generating a recommendation to the first user to respond to a received message.

11. The method of claim 1, wherein the change in circumstance is associated with a relative importance of the electronic message.

12. The method of claim 1, wherein proposing the alternative communication type for sending the version of the electronic message includes the large language model suggesting at least one of a change in formality or conciseness of the electronic message.

13. The method of claim 1, wherein the set of criteria includes at least criterion that is based on user input.

14. The method of claim 1, wherein proposing the alternative communication type for sending the version of the electronic message includes one of:
switching from a textual message to an audio message;
switching from an email message to a blog or social media post;
switching from a chat message to a blog or social media post; or
switching from an instant message to a blog or social media post.

15. A processing system, comprising:
memory configured to store an electronic message to be sent on behalf of a first user; and
one or more processors operatively coupled to the memory, the one or more processors being configured to:
identify a scheduled future time to send the electronic message on behalf of the first user to one or more other users;
determine, based on a set of criteria using a trained large language model, that there has been a change in circumstance associated with the electronic message; and
in response to the determining that there has been a change in the circumstance based on the set of criteria, perform at least one of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message;
wherein automatically changing the scheduled future time is performed when the criteria includes a state of an inbox associated with the first user, a state of a communication channel associated with the first user, a status of one of the one or more other users, or an action of one of the one or more other users.

16. The processing system of claim 15, wherein the one or more processors are configured perform at least two of (1), (2), (3) and (4).

17. The processing system of claim 15, wherein the set of criteria is created using the large language model.

18. The processing system of claim 15, wherein the large language model is configured to update the set of criteria based on one or more of the state of the inbox, the state of the communication channel, the status of one of the one or more other users, or the action of one of the one or more other users.

19. A computer-readable medium having instructions stored thereon, the instructions, when executed by one or more processors of a computing system, performing a method for electronic communication, the method comprising:
identifying a scheduled future time to send an electronic message on behalf of a first user to one or more other users;
determining, based on a set of criteria using a trained large language model, that there has been a change in circumstance associated with the electronic message; and
in response to the determining that there has been a change in the circumstance based on the set of criteria, performing each of (1) automatically changing the scheduled future time to either an earlier time or a later time, (2) notifying the first user of the changing of the schedule future time or the change in circumstance, (3) creating an alternative version of the electronic message, or (4) proposing an alternative communication type for sending a version of the electronic message;
wherein automatically changing the scheduled future time is performed when the criteria includes a state of an inbox associated with the first user, a state of a communication channel associated with the first user, a status of one of the one or more other users, or an action of one of the one or more other users.

20. The computer-readable medium of claim 19, wherein notifying the first user of the changing of the schedule future time or the change in circumstance includes the large language model generating a recommendation to the first user to respond to a received message.
